(19) United States
(12) Patent Application Publication
(10) Pub. No.: US 2014/0270931 A1
(43) Pub. Date: Sep. 18, 2014

(54) PET TOY

(71) Applicant: Claudius Jäger, Boulder, CO (US)

(72) Inventor: Claudius Jäger, Boulder, CO (US)

(73) Assignee: Artemis Rubber Technology, Longmont, CO (US)

(21) Appl. No.: 13/836,463

(22) Filed: Mar. 15, 2013

(51) Int. Cl. A01K 15/02

(52) U.S. Cl. CPC A01K 15/025
USPC 403/343; 29/407.1

(57) ABSTRACT

A pet toy having a first part with internal threads, and a second part having external threads. When the first and second parts are threaded together by interengagement of their internal and external threads, they cooperate frictionally with one another to prevent, or at least to make difficult, an unintentional unthreading of the two parts from one another, wherein the threaded-together parts form a pet toy. To make unintentional unthreading even more difficult, additional engagement means can be provided on the first part and additional cooperating second engagement means can be provided on the second part.

### BACKGROUND OF THE INVENTION

The present invention relates to a pet toy, and in particular to a mechanism and procedures for connecting together two components to form a pet toy.

It is an object of the present invention to provide a reliable mechanism and procedures for connecting together two components to form a pet toy, and to make unintentional coming apart of the components at least difficult.

### BRIEF DESCRIPTION OF THE DRAWINGS

This object, and other objects and advantages of the present invention, will appear more clearly from the following specification in conjunction with the accompanying schematic drawings, in which:

FIG. 1 shows one exemplary embodiment of applicant's pet toy in an assembled or threaded-together state;

FIG. 2 shows a first exemplary embodiment of the pet toy of FIG. 1 in an unthreaded state;

FIG. 3 is a cross-sectional view of the pet toy components of FIG. 2 taken along the line A-A thereof;

FIG. 4 is a perspective view of the pet toy components of FIG. 2;

FIG. 5 shows a second exemplary embodiment of the pet toy of FIG. 1 in an unthreaded state;

FIG. 6 is a cross-sectional view of the pet toy components of FIG. 5 taken along the line A-A thereof;

FIG. 7 is a perspective view of the pet toy components of FIG. 5;

FIG. 8 is a further perspective view of the pet toy components of FIG. 5;

FIG. 9 shows an alternative configuration for the recesses of the first engagement means;

FIGS. 10&11 show a third exemplary embodiment of the pet toy of FIG. 1 in an unthreaded state;

FIGS. 12-14 show exemplary embodiments of differently shaped ones of applicant's pet toys in an unthreaded state;

FIG. 15 shows an exemplary embodiment of a differently shaped one of applicant's pet toys;

FIG. 16 is a perspective view of the pet toy of FIG. 15 with the part 15 and prior to being threaded in;

FIG. 17 shows another exemplary embodiment of a differently shaped one of applicant's pet toys;

FIG. 18 is a cross-sectional view of the first part of the pet toy of FIG. 19 showing the internal threads thereof for receiving the second part;

FIG. 19 shows the second part of the pet toy of FIG. 19 in the form of a spindle;

FIG. 20 is an exemplary embodiment of a modification for the shape of the first part of the pet toy of FIG. 19;

FIGS. 21 a&b show a further exemplary embodiment of applicant's pet toy with the second part being in the form of an edible plug; and

FIG. 22 is another exemplary embodiment of a differently shaped one of applicant's pet toys in which is disposed a further device.

### SUMMARY OF THE INVENTION

The pet toy of the present application comprises a first part that has internal threads; a second part that is provided, for example on a recessed portion or merely on a peripheral surface thereof, with external threads that are configured to interengage the internal threads of the first part; wherein, when the first and second parts are threaded together by interengagement of their internal and external threads, they cooperate frictionally with one another to prevent, or at least to make difficult, an unintentional unthreading of the first and second parts from one another; and wherein when the first and second parts are threaded together they form a pet toy. First engagement means can be provided on the first part in addition to the internal threads; and second engagement means can be provided on the second part in addition to the external threads thereof, wherein, when the first and second parts are threaded together by interengagement of their internal and external threads, the first and second engagement means cooperate with one another to prevent, or at least to make difficult, the unintentional unthreading of the first and second parts from one another.

If the first part of the pet toy has a planar, radially extending surface, and a recessed portion of the second part has a planar, radially extending surface, the first and second parts can be threaded together by axially aligning the first and second parts such that their radially extending surfaces face one another; moving the first and second parts toward one another; and causing the external threads of the second part to be threaded into the internal threads of the first part. If engagement means are provided, the first and second parts can continue to be threaded together until their first and second engagement means cooperate with one another and the radially extending surfaces of the first and second parts abut against one another. Unthreading of the first and second parts from one another can be accomplished, perhaps by additionally squeezing together approximately opposite outer surfaces of at least one of the first and second parts in the vicinity of the radially extending surfaces, by causing at least one of the first and second parts to be rotated in an unthreading direction; and continuing such unthreading action until the first and second parts are separated from one another.

Further specific features of the present application will be described in detail subsequently.

### DESCRIPTION OF SPECIFIC EMBODIMENTS

Referring now to the drawings in detail, shown are several exemplary embodiments of applicant's pet toy, which is indicated generally by the reference numerals 10, 10A, etc. In the exemplary spherical or egg-shaped embodiment of FIGS. 1-4, the pet toy 10 is comprised of two parts or components 11 and 15, which when threaded together, as depicted in FIG. 1, form the pet toy 10 which is in this embodiment has a hollow central cavity.

As can be best seen in FIGS. 3 and 4, the first part or component 11 of the pet toy 10 is, in this illustrated embodiment, substantially in the shape of a hemisphere, and has a hollow interior 12 with a corresponding substantially hemispherical shape that makes up most of the volume of the first part 11. In the vicinity of the outwardly facing and radially extending surface 17 of the first part 11, as viewed in a disassembled state of the pet toy 10, part of the surface of the hollow interior 12 of the first part 11 is provided with internal threads 14. The second part or component 15 is also substantially in the shape of a hemisphere, and has a hollow interior 18, although the second part 15 could also be a solid component. However, by providing the second part 15 with a hollow interior 18, the pet toy 10 can be provided with a larger hollow central cavity, for purposes to be described subsequently.

To provide the second part 15 with means to allow a cooperating interengagement between the second part 15 and the first part 11, the second part 15 has a peripheral recessed portion 19 in the vicinity of the outwardly facing surface 20 of the second part 15, again as viewed in the disassembled state of the pet toy 10. The recessed portion 19 has a base 21 in the form of a further outwardly facing and radially extending surface. Provided on the substantially axially extending peripheral surface 22 between the two substantially radially extending outwardly facing surfaces 20 and 21 of the second part 15 are external threads 23 that are configured to cooperate with the internal threads 14 of the first part 11 in a manner to be described subsequently.

To assemble or form the pet toy 10, the first and second parts 11 and 15 are axially aligned with one another such that their outwardly facing surfaces 17 and 20, 21 face one another. The two parts 11 and 15 are then moved toward, and rotated relative to, one another such that the external threads 23 of the second part 15 can be threaded into the internal threads 14 of the first part 11 until the outwardly facing surfaces 17 and 21 of the first and second parts 11 and 15 respectively abut one another, as shown in FIG. 1. The interengaging threads 14 and 23 of the two parts 11 and 15 can by themselves be sufficient to prevent an unintentional unthreading of the first and second parts 11 and 15 from one another, or to at least make such an unthreading difficult. In particular, when the first and second parts 11 and 15 are threaded tightly together, the cooperating threads 14 and 23 thereof deform somewhat, causing a frictional resistance to any unthreading action, especially by a pet. As a matter of fact, when a pet places the toy 10 in its mouth and causes the toy 10 to deform, this deformation causes a further locking down of the cooperating threads 14 and 23, thus enhancing the fictional interlocking effect. A person, however, can unthread the two parts 11 and 15 merely by applying sufficient torque in an unthreading direction.

In addition to the threads 14 and 23, to help prevent the unintentional unthreading of the first and second parts 11 and 15 from one another, or at least to make such an unthreading difficult, cooperating engagement means can be provided on the two parts 11 and 15. In particular, in the embodiment of applicant's pet toy illustrated in FIGS. 2-4, first engagement means 25 are provided in the outwardly facing surface 17 of the first part 11, and second engagement means 26 are provided on the outwardly facing surface 21 of the second part 15. The second engagement means 26 is in the form of two or more short ramps that start at the level of the outwardly facing surface 21 and extend away from this outwardly facing surface, as shown in FIGS. 2 and 3. The first engagement means 25 is in the form of two or more for example sloped recesses that are formed within the outwardly facing surface 17 and that can have a complementary shape to that of the ramps 26. The cooperating ramps 26 and recesses 25 are configured and arranged such that as the outwardly facing surfaces 17 and 21 approach one another during the process of threading the first and second parts 11 and 15 together, the for example elastomeric material of the higher portions of the ramps or second engagement means 26 of the second part 15 are compressed as they move over the outwardly facing surface 17 of the first part 11 prior to the ramps 26 being received in the recesses or first engagement means 25. When the first and second parts 11 and 15 are completely threaded together, the facing surfaces 17 and 21 abut one another, and the ramps 26 are completely accommodated in the recesses 25. Since an attempted rotation of the first and second parts 11 and 15 in an unthreading direction will cause the substantially axially extending back surfaces 27 of the higher portions of the ramps 26 to encounter the similarly substantially axially extending surfaces 28 of the recesses 25, the first and second parts 11 and 15 cannot be unthreaded from one another without a special manipulation of the second part 15. In particular, to be able to unthread the first and second parts 11 and 15 from one another, rather than squeezing one or both of the parts 11 and 15, as a pet would, and which as explained above enhances the frictional engagement, a person again merely has to apply sufficient torque in an unthreading direction to release the ramps 26 from the recesses 25 in order to allow unthreading to proceed. This manipulation is difficult for a pet to achieve.

Although in the foregoing the ramps 26 have been described as being disposed on the outwardly facing surface 21 of the second part 15, and the cooperating recess 25 have been described as being disposed in the outwardly facing surface 17 of the first part 11, it is to be understood that the ramps could instead be disposed on the first part 11, while the recesses could be disposed in the second part 15. Such interchangeability of course applies also to the embodiments that will be described subsequently.

In the embodiment illustrated in FIGS. 5-8, the cooperating engagement means 25 and 26, rather than being disposed in the facing surfaces 17 and 21 of the first and second parts 11 and 15, as is the case in the embodiment of FIGS. 2-4, are disposed in facing, substantially axially extending, surfaces of the first and second parts 11 and 15. In particular, in the first part 11, the internal threads 14, rather than starting at the outwardly facing surface 17, are recessed from the surface 17, leaving a short axially extending, and inwardly facing, surface 30 that is disposed between the outwardly facing surface 17 and the start of the internal threads 14. The first engagement means or recesses 25 are then provided in this inwardly facing surface 30. Similarly, in the second part 15, the external threads 23 do not extend all the way from the outwardly facing surface 20 to the base 21 of the recessed portion 19 of the second part 15, but rather stop short of the base or further outwardly facing surface 21, leaving a short axially extending, and outwardly facing, surface 31 that is disposed between the surface 21 and the external threads 23. The second engagement means or ramps 26 are then provided on this outwardly facing surface 31, which corresponds substantially in axial length to that of the inwardly facing surface 30 of the first part 11. The configuration, arrangement and operation of the ramps 26 and recesses 25 of this embodiment are comparable to those of the embodiment of FIGS. 2-4.

In the previously described embodiments, the first engagement means 25 provided in the outwardly facing surface 17 of the first part 11 were in the form of spaced-apart ramp-shaped recesses having a shape complementary to that of the cooperating ramp-shaped second engagement means 26 provided on the outwardly facing surface 21 of the second part 15. However, other configurations for the first engagement means 25 could also be provided. For example, in the embodiment of applicant's pet toy 10B illustrated in FIG. 9, the first engagement means 25 are in the form of a plurality of uniformly shaped recesses, which have a uniform depth and are distributed over the entire outwardly facing surface 17. The recesses 25 of this embodiment are separated from one another by radially extending ribs 34 that provide axially extending surfaces 35 that, similar to the axially extending surfaces 28 of the recesses 25 of the previously described embodiments, provide an abutment surface for engagement against the axially extending back surfaces 27 of the ramps or second engagement means 26 of the second part 15. It should be noted that the notches or recesses 25 that are shown in the outwardly facing surface 17 in the embodiment of FIG. 9 could similarly replace the recesses or first engagement means 25 of the embodiment illustrated in FIGS. 5 to 7.

Although in the embodiments just described the ramps 26 are disposed on only one of the two parts 11 and 15 of the pet toy, while the cooperating recesses are provided for only the other of the two parts, it would also be possible, as shown in the embodiment of the pet toy 10C illustrated in FIGS. 10 and 11, to combine the configurations of the two previously described embodiments. Thus, both of the surfaces 21 and 31 of the second part 15 are provided with ramps 26, while both of the surfaces 17 and 30 of the first part 11 are provided with recesses 25.

Although in the embodiments illustrated in FIGS. 1-11 the pet toy 10-10 C formed by threading the first and second parts 11 and 15 together has a spherical shape, any other shape that can be formed by threading together an internally threaded part and an externally threaded part is possible. For example, reference will now be made to the pet toys 10D to 10F illustrated in FIGS. 12-14 respectively.

In the embodiment of the pet toy 10D illustrated in FIG. 12, the first part 11 has a substantially cylindrical shape, while the second part 15 is a smaller part that forms a threaded lid or plug for the first part. In view of a less pronounced recessed portion 19, the internal threads 14 of the first part 11 are recessed from the surface 17, in a manner comparable to that described in conjunction with the embodiment illustrated in FIGS. 5-8. Similarly, the external threads 23 of the second part 15 are spaced from the surface 21 of the recessed portion 19. In conformity therewith, the first engagement means or recesses 25 are disposed in the peripheral surface 30 that is formed between the outer surface 17 and the internal threads 14 of the first part 11. Similarly, the second engagement means or ramps 26 are provided on the peripheral surface 31 that is formed between the surface 21 of the recessed portion 19 and the external threads 23 of the second part 15. Threading together of the two parts 11 and 15, and unthreading thereof, proceed in the same manner as described in conjunction with the embodiment of FIGS. 5-8.

In the embodiment of the pet toy 10D illustrated in FIG. 12, the surfaces 17 and 21 of the first and second parts 11 and 15 respectively need not necessarily be planar. Nonetheless, the surfaces 17 and 21 will abut one another when the second part 15 is threaded entirely into the first part 11. In addition, the second part 15 can be provided with means 33, such as in the form of the illustrated ribs, to assist in threading the second part 15 into and out of the first part 11. Although the means 33 are shown in that surface of the second part 15 that faces away from the first part 11, such means could also be provided in a peripheral surface of the second part 15, either as projecting ribs or as indented recesses.

The embodiment of the pet toy 10E illustrated in FIG. 13 shows another alternative shape for the pet toy. In this embodiment, the first part 11 has a cubic or box-shaped configuration, with the second part 15 having a shape comparable to that illustrated in the embodiment of FIG. 12. Since in this embodiment the first part 11 has a square or rectangular cross section, when the second part 15 is threaded into the first part 15 portions of the surface 17 of the first part will be exposed at the corners of the surface 17 of the first part.

The embodiment of the pet toy 10F illustrated in FIG. 14 shows yet another alternative shape for applicant's pet toy. In this embodiment, the first part 11 has an irregular configuration, with the second part 15 again having a shape comparable to that illustrated in the embodiment of FIG. 12. As indicated above, although specific shapes have been illustrated, applicant's pet toy is in no way limited to such illustrated examples.

Although in the previously described embodiments, the assembled pet toy 10 has an at least somewhat hollow interior, for example to save material, provide a deformable toy, and/or to provide a space for treats, other configurations are also possible. For example, applicant's pet toy 10H illustrated in FIGS. 15 and 16 has little, if any, hollow interior when the first and second parts 11 and 15 are threaded together; the assembled state of the pet toy 10H is illustrated in FIG. 15, and shows a treat T, for example a treat made of corn starch, cookie dough or galantine, being held in the second part 15.

Although not specifically shown in FIG. 16, the first and second parts 11 and 15 of the pet toy 10H can again be provided with the first and second engagement means 25 and 26 to prevent, or at least to make difficult, an unintentional unthreading of the first and second parts 11 and 15 from one another.

In the previously described embodiments of FIGS. 12 to 14, the second part 15 was a plug that threaded into the first part 11 to close off the whole interior of the pet toy. In the exemplary embodiments of applicants pet toys 10I and 10J illustrated in FIGS. 19 and 22, the plug or second part 15 is in the form of a threaded, possibly edible spindle that is threaded into the internal threads 14 of the first part 11 (see also FIG. 20). If edible, the spindle 15 is hard, or flexible and is made, for example, of corn starch, cookie dough, galantine or any other suitable edible material.

As can be seen in FIG. 19, the second part 15, which as indicated above is in the form of a spindle-shaped plug, is provided with a recessed, and preferably hollow, portion 46 that is configured to allow insertion of a correspondingly shaped tool to facilitate threading-in of the spindle 15, and unthreading of an unconsumed residue thereof that remains in the first part 11 to allow insertion of a new spindle 15.

FIG. 20 illustrates another exemplary embodiment of applicant's pet toy. The pet toy 10J of FIG. 20 is comparable to the pet toy 10I of FIGS. 19 to 21, and differs only in the shape of the first part 11, which in this embodiment is cylindrical rather than spherical. Again, it should be noted that the first part 11 is not limited to merely the illustrated shapes, and any other shape, including the shapes illustrated in FIGS. 13 and 14, would be possible.

An edible second part 15 is not limited to the spindle shape of the embodiments of FIGS. 17 to 20. Rather, the plugs or second parts 15 of the previously described embodiments can also be edible. One specific embodiment of such an edible plug 15 and its cooperating first part 11 are illustrated in FIGS. 21a and 21b. In this embodiment, the edible plug 15 is also provided with an aperture 48, especially for the insertion of further treats into the first part 11, and/or for the insertion of a suitable tool to be used as described in conjunction with the hollow recessed portion 46 of the spindle 15 described above.

Finally, the first part 11 can also contain a further pet-stimulating device, such as a visual or acoustical device, including squeakers. In the embodiment of applicant's pet toy 10K illustrated in FIG. 22, a helical, ramp-like insert 49 is disposed in the first part 11, which in this embodiment, by way of example only, is in the form of yet another exemplary shape of applicant's pet toy. Treats loaded into the first part 11 can be moved along the ramps of the insert 49 when a dog or other pet plays with the toy 10K. The first part 11 of the toy 10K has a plug 15, for example similar in configuration to the plugs of the embodiments illustrated in FIGS. 12 to 14, which is threaded into an opening of the first part 11 that is provided with the internal threads 14. The opposite end of the first part 11 can be provided with an aperture 50 for the insertion, and removal by pet, of treats.

The two parts 11 and 15 of the various described pet toys can be made of the same or different materials, such as natural rubber, elastomeric or a polymeric material, especially elastomeric polyurethane, polymerized polyisoprene, KRATON®, hard plastic unfilled PA polyamid or polypropylene, or other hard plastic polymers. However, at least that part 11 and/or 15 that is provided with engagement means in the form of ramps should be made of a somewhat flexible elastomeric material in order to allow deformation of at least the recesses and release of the ramps from the recesses of the cooperating part. The material of at least one of the parts 11 and 15 could also be translucent. In a presently preferred embodiment, one of the two parts 11 and 15 is made of a soft and flexible elastomeric material, while the other part 15 or 11 is made of a hard polymeric material. As indicated above, this other part could also be made of a hard and edible material.

The present invention is, of course, in no way restricted to the specific disclosure of the specification and drawings, but also encompasses any modifications within the scope of the appended claims.

What I claim is:

1. A pet toy, comprising:
a first part (11), wherein said first part is provided with internal threads (14);
a second part (15), wherein said second part is provided with external threads (23) that are configured to interengage said internal threads (14) of said first part (11);
wherein, when said first and second parts (11, 15) are threaded together via interengagement of said internal and external threads (14, 23), said internal and external threads frictionally cooperate with one another to prevent, or to at least make difficult, an unintentional unthreading of said first and second parts (11, 15) from one another; and
wherein when said first and second parts are threaded together, they form said pet toy (10).

2. A pet toy according to claim 1, wherein said first part (11) has a substantially radially extending surface (17), further wherein said second part (15) is provided with a recessed portion (19), further wherein said recessed portion (19) has a substantially radially extending surface (21), and wherein, when said first and second parts (11, 15) are threaded together, said radially extending surfaces (17, 21) are configured to abut one another.

3. A pet toy according to claim 2, wherein a first engagement means is provided on said first part in addition to said internal threads, further wherein a second engagement means is provided on said second part in addition to said external threads, and wherein when said first and second parts are threaded together, said first and second engagement means cooperate frictionally with one another to prevent, or at least to make difficult, said unintentional unthreading of said first and second parts from one another.

4. A pet toy according to claim 3, wherein said first engagement means (25) are disposed in or on said radially extending surface (17) of said first part (11), and wherein said second engagement means (26) are disposed on or in said radially extending surface (21) of said second part (15).

5. A pet toy according to claim 4, wherein said first engagement means (25) are in the form of recesses disposed in said radially extending surface (17) of said first part (11) or are ramps extending from said radially extending surface (17) of said first part, and wherein said second engagement means (26) are in the form of ramps extending from said radially extending surface (21) of said second part (15) or recesses disposed in said radially extending surface (21) of said second part (15).

6. A pet toy according to claim 4, wherein said internal threads (14) of said first part (11) begin immediately adjacent said radially extending surface (17) of said first part, and wherein said external threads (23) of said second part (15) begin immediately adjacent said radially extending surface (21) of said second part.

7. A pet toy according to claim 3, wherein a substantially axially extending, inwardly facing, surface (30) is disposed between said radially extending surface (17) of said first part (11) and a beginning of said internal threads (14), further wherein a substantially axially extending, outwardly facing, surface (31) is disposed between said radially extending surface (21) of said second part (15) and a beginning of said external threads (23), further wherein when said first and second parts (11, 15) are threaded together, said axially extending surfaces 30 and 31 are configured to be disposed adjacent to one another, further wherein said first engagement means (25) are disposed in or on said axially extending surface (30) of said first part (11), and wherein said second engagement means (26) are disposed on or in said axially extending surface (31) of said second part (15).

8. A pet toy according to claim 7, wherein said first engagement means (25) are in the form of recesses disposed in said axially extending surface (30) of said first part (11) or ramps extending from said axially extending surface (30) of said first part, and wherein said second engagement means (26) are in the form of ramps extending from said axially extending surface (31) of said second part (15) or recesses disposed in said axially extending surface (31) of said second part.

9. A pet toy according to claim 7, wherein a beginning of said internal threads (14) of said first part (11) is spaced from said radially extending surface (17) of said first part, and wherein a beginning of said external threads (23) of said second part (15) is spaced from said radially extending surface (21) of said second part.

10. A pet toy according to claim 2, wherein said external threads (23) of said second part (15) extend peripherally about said recessed portion (19).

11. A pet toy according to claim 1, where at least one of said first and second parts (11, 15) is deformable to permit disengagement of said first engagement means (25) of said first part (11) and said second engagement means (26) of said second part (15) from one another, and hence to permit unthreading of said first and second parts (11, 15) from one another.

12. A pet toy according to claim 2, wherein said first and second parts (11, 15) each have a hemispherical shape, so that when said first and second parts are threaded together, said pet toy (10) has a spherical shape.

13. A pet toy according to claim 11, wherein said first part (11) has a hollow interior (12), further wherein said second part (15) also has a hollow interior (18), and wherein said pet toy has a hollow central cavity formed by said hollow interiors (12, 18) of said first and second parts (11, 15).

14. A pet toy according to claim 1, wherein said first part (11) has a rounded, cylindrical, cubic, box-shaped or other multi-sided or irregular configuration, and wherein said second part (15) forms a threaded lid or plug for said first part (11).

15. A pet toy according to claim 1, wherein said second part (15) is substantially disk-shaped, and wherein said second part (15) has an aperture (41) configured to accommodate a treat (T).

16. A pet toy according to claim 15, wherein said first part (11) has a substantially radially extending surface, further wherein said disk-shaped second part (15) has a substantially radially extending surface, and wherein when said first and second parts (11, 15) are threaded together, said substantially radially extending surfaces of said first and second parts are adapted to be substantially flush with one another.

17. A pet toy according to claim 5, wherein said recesses (25) have a shape that is complementary to the shape of said ramps (26), or said recesses (25) have a constant depth and are distributed over the entire radially extending surface (17) of said first part (11) or over the entire radially extending surface (21) of said second part (15).

18. A pet toy according to claim 1, wherein said second part has the shape of a threaded spindle.

19. A pet toy according to claim 1, wherein an insert is disposed within said first part.

20. A method of threading together the first and second parts (11, 15) of the pet toy (10) of claim 3, including the steps of:
axially aligning said first and second parts (11, 15) such that their radially extending surfaces (17, 21) face one another;
moving said first and second parts (11, 15) toward one another;
causing said external threads (23) of said second part (15) to be threaded into said internal threads (14) of said first part (11); and
continuing threading said first and second parts (11, 15) together until said first engagement means (25) of said first part (11) and said second engagement means (26) of said second part (15) cooperate with one another, and said radially extending surfaces (17, 21) of said first and second parts (11, 15) abut against one another.

21. A method of unthreading the first and second parts (11, 15) of the pet toy (10) of claim 3 from one another, including the steps of:
causing at least one of said first and second parts (11, 15) to be rotated in an unthreading direction; and
continuing unthreading action until said first and second parts (11, 15) are separated from one another.
